(19) United States
(12) Patent Application Publication
(10) Pub. No.: US 2026/0086820 A1
(43) Pub. Date: Mar. 26, 2026

(54) DEVICE AND METHOD FOR MODEL AND RECONFIGURABLE HARDWARE

(71) Applicant: Industrial Technology Research Institute, Hsinchu (TW)

(72) Inventors: Yan-Ying Li, Taipei City (TW); Kuen-Wey Lin, Hsinchu County (TW); Bo-Cheng Lai, Kaohsiung City (TW); Yi-Ting Wu, Taipei City (TW); Tzu-Yun Yen, Kaohsiung City (TW); Yu-Pei Lin, Taoyuan City (TW)

(73) Assignee: Industrial Technology Research Institute, Hsinchu (TW)

(21) Appl. No.: 18/951,659

(22) Filed: Nov. 19, 2024

(30) Foreign Application Priority Data
Sep. 26, 2024 (TW) 113136672

(51) Int. Cl. G06F 9/445

(52) U.S. Cl. CPC G06F 9/44505

(57) ABSTRACT

A device and a method for a model and a reconfigurable hardware are provided. The method includes following steps: setting a number of pipeline stages and dividing points of pipelines as a software parameter, and setting a tiling size, the number of a processing element, and a size of the processing element as a hardware parameter, where a segmented model includes the pipeline stages and the dividing points, and the processing element corresponds to the reconfigurable hardware; compiling the segmented model by a machine learning compiler to obtain a host code; synthesizing a bitstream of the reconfigurable hardware by a high-level synthesis tool and the hardware parameter; and obtaining execution time corresponding to the host code and the bitstream.

### CROSS-REFERENCE TO RELATED APPLICATION

This application claims the priority benefit of Taiwan application serial no. 113136672, filed on Sep. 26, 2024. The entirety of the above-mentioned patent application is hereby incorporated by reference herein and made a part of this specification.

### TECHNICAL FIELD

The disclosure relates to a device and a method for a model and a reconfigurable hardware.

### BACKGROUND

Currently, for reconfigurable hardware, machine learning compilers cannot integrate model (software) division and resource (hardware) configuration, which leads to model deployment failure.

### SUMMARY

The disclosure provides a device and a method for a model and a reconfigurable hardware, which can integrate software and hardware to optimize model performance.

A device for a model and a reconfigurable hardware of the disclosure includes a processor, where the processor is configured to execute the following steps. S1: The processor sets a number of pipeline stages and dividing points of pipelines as a software parameter, and sets a tiling size, a number of a processing element, and a size of the processing element as a hardware parameter, where a segmented model includes the pipeline stages and the dividing points, and the processing element corresponds to the reconfigurable hardware. S2: The processor compiles the segmented model by a machine learning compiler to obtain a host code. S3: The processor synthesizes a bitstream of the reconfigurable hardware by a high-level synthesis tool and the hardware parameter. S4: The processor obtains execution time corresponding to the host code and the bitstream.

A method for a model and a reconfigurable hardware of the disclosure is adaptable for a device including a processor, where the method includes the following steps. S1: A number of pipeline stages and dividing points of pipelines are set as a software parameter by the processor, and a tiling size, a number of a processing element, and a size of processing element are set as a hardware parameter by the processor, where a segmented model includes the pipeline stages and the dividing points, and the processing element corresponds to the reconfigurable hardware. S2: The segmented model is compiled by the processor by a machine learning compiler to obtain a host code. S3: A bitstream of the reconfigurable hardware is synthesized by the processor by a high-level synthesis tool and the hardware parameter. S4: Execution time corresponding to the host code and the bitstream is obtained by the processor.

Based on the above, the device and the method for the model and the reconfigurable hardware of the disclosure may set the number of pipeline stages and the dividing points of the pipelines as the software parameter, and set the tiling size, the number of the processing element, and the size of the processing element as the hardware parameter. Subsequently, the execution time corresponding to the host code and the bitstream may be obtained. Furthermore, the device and the method for the model and the reconfigurable hardware of the disclosure may obtain the optimized software parameter and the optimized hardware parameter. Accordingly, the device and the method for the model and the reconfigurable hardware of the disclosure may pipeline the model, and may simultaneously consider the resources of the reconfigurable hardware, thereby integrating software and hardware to optimize model performance.

### BRIEF DESCRIPTION OF THE DRAWINGS

FIG. 1 is a schematic diagram illustrating a device for a model and a reconfigurable hardware according to an example of the disclosure.

FIG. 2 is a flowchart illustrating a method for a model and a reconfigurable hardware according to an example of the disclosure.

### DETAILED DESCRIPTION OF DISCLOSED EMBODIMENTS

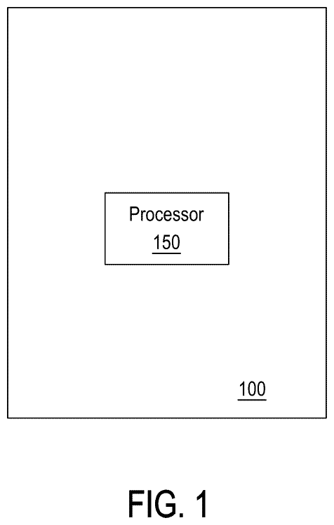

FIG. 1 is a schematic diagram illustrating a device 100 for a model and a reconfigurable hardware according to an example of the disclosure. The device 100 may include a processor 150. In other embodiments, the device 100 may include a storage medium (not shown) and a transceiver (not shown) coupled to the processor 150.

The processor 150 is, for example, a central processing unit (CPU), or a programmable micro control unit (MCU) for a common purpose or a specific purpose, a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA) or other similar elements or a combination of the thereof. The processor 150 may access and execute multiple modules and various applications stored in the storage medium.

In an embodiment, the reconfigurable hardware may include a field programmable gate array (FPGA). However, the disclosure is not limited thereto.

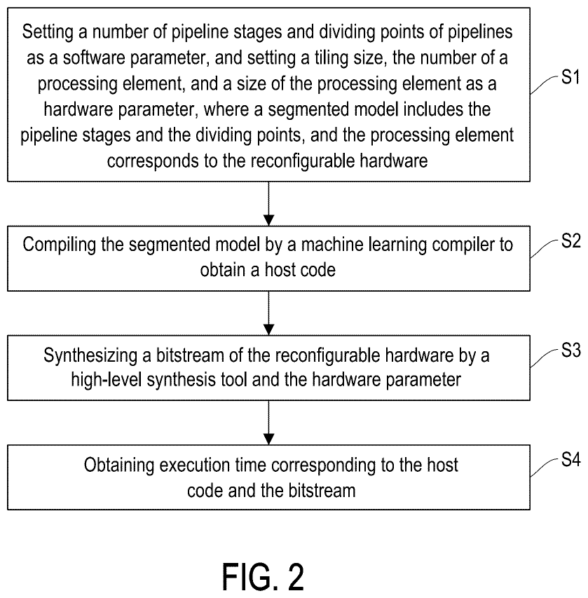

FIG. 2 is a flowchart illustrating a method for a model and a reconfigurable hardware according to an example of the disclosure, where the method may be implemented by the device 100 shown in FIG. 1. Please refer to FIG. 1 and FIG. 2 together.

In step S1, the processor 150 may set the number of pipeline stages and a dividing points of pipelines as a software parameter, and may set a tiling size, a number of a processing element, and a size of the processing element as a hardware parameter. A segmented model may include the pipeline stages and the dividing points. The processing element may correspond to the reconfigurable hardware.

In an embodiment, a trained model may include an operator. Before executing step S1, the processor 150 may obtain operator execution time corresponding to the operator. Then, the processor 150 may segment the trained model into the aforementioned segmented model.

In an embodiment, the processing element may include an adder tree, where a number of the adder tree may be Tₘ. Furthermore, the adder tree may include a multiplier, where a number of the multiplier may be Tₙ. More specifically, the size of the processing element may be Tₙ. In another aspect, the number of the processing element may be Tₘ.

In an embodiment, the tiling size may correspond to Tᵣ and T_{c}. Specifically, the processor 150 may input a tensor to the reconfigurable hardware. Then, the processor 150 may tile the tensor into Tᵣ rows and T_{c} columns.

Please continue to refer to FIG. 2. In step S2, the processor 150 may compile the segmented model by a machine learning compiler to obtain a host code. In an embodiment, the processor 150 may annotate the pipeline stages and the dividing points in the segmented model by the intermediate representation of the machine learning compiler. Accordingly, the machine learning compiler may optimize the segmented model to obtain the host code. In an embodiment, the processor 150 may enable an accelerator hardware driver for the reconfigurable hardware in the machine learning compiler.

In step S3, the processor 150 may synthesize a bitstream of the reconfigurable hardware by a high-level synthesis tool and the hardware parameter.

In step S4, the processor 150 may obtain execution time corresponding to the host code and the bitstream. In an embodiment, the processor 150 may obtain the execution time corresponding to the host code and the bitstream by the aforementioned operator execution time.

In an embodiment, the execution time may include initial execution time and current execution time. When the current execution time is greater than or equal to the initial execution time, the processor 150 may re-execute steps S1 to S4. Specifically, the processor 150 may execute steps S1 to S4 by an initial software parameter and an initial hardware parameter to obtain the initial execution time. Then, the processor 150 may execute steps S1 to S4 again by the updated software parameter and the updated hardware parameter to obtain the current execution time. If the processor 150 determines that the current execution time is greater than or equal to the initial execution time, the processor 150 may re-execute steps S1 to S4. In another aspect, if the processor 150 determines that the current execution time is less than the initial execution time, the processor 150 may accept/adopt the updated software parameter and the updated hardware parameter. In other words, the processor 150 may obtain the optimized software parameter and the optimized hardware parameter.

In an embodiment, if the processor 150 determines that the current execution time stops decreasing (or starts increasing) in consistently a specified number of iterations, the processor 150 may no longer re-execute steps S1 to S4.

Table 1 is an example of the software parameter, hardware parameter, and utilization of the reconfigurable hardware in the disclosure.

TABLE 1

| | Software | | Hardware | | | |
|---|---|---|---|---|---|---|
| | Parameters | | Parameters | | | |
| | (Convolutional | | (Tᵣ, T_{c}, | LUT | DSP | BRAM |
| | Layer) | GFLOPS | Tₙ, Tₘ) | Utilization | Utilization | Utilization |
| First stage | 1-3 | 5.72 | (14, 28, 2, 64) | 19% | 14% | 10% |
| Second Stage | 4-6 | 9.25 | (28, 14, 8, 48) | 26% | 36% | 18% |
| Third Stage | 7-9 | 9.25 | (28, 14, 8, 28) | 17% | 23% | 27% |
| Fourth Stage | 10-13 | 6.46 | (14, 14, 16, 16) | 19% | 24% | 12% |
| Sum | — | 30.68 | — | 81% | 97% | 67% |

Table 2 shows the evaluation results of the disclosure using the VGG16 model. As shown in Table 2, the time for processing one piece of data may be compressed to 258 ms. Compared to using CPU only, the disclosure may achieve a 23.65-fold acceleration in execution time.

TABLE 2

| | | CPU and reconfigurable |
|---|---|---|
| | CPU | hardware |
| Execution | 6101 | 258 |
| Time (ms) | | |
| Compile | 121 | 145 |
| Time(s) | | |
| Speedup factor | 1 | 23.65 |
| of execution | | |
| time | | |

In summary, the device and the method for the model and the reconfigurable hardware of the disclosure may set the number of pipeline stages and the dividing points of the pipelines as the software parameter, and set the tiling size, the number of the processing element, and the size of the processing element as the hardware parameter. Subsequently, the execution time corresponding to the host code and the bitstream may be obtained. Furthermore, the device and the method for the model and the reconfigurable hardware of the disclosure may obtain the optimized software parameter and the optimized hardware parameter. Accordingly, the device and the method for the model and the reconfigurable hardware of the disclosure may pipeline the model and simultaneously consider the resources of the reconfigurable hardware, thereby integrating the software and hardware to optimize model performance.

What is claimed is:

1. A device for a model and a reconfigurable hardware, comprising:
a processor, wherein the processor is configured to execute following steps:
S1: setting a number of pipeline stages and dividing points of pipelines as a software parameter, and the setting a tiling size, a number of a processing element, and a size of the processing element as a hardware parameter, wherein a segmented model comprises the pipeline stages and the dividing points, and the processing element corresponds to the reconfigurable hardware;
S2: compiling the segmented model by a machine learning compiler to obtain a host code;
S3: synthesizing a bitstream of the reconfigurable hardware by a high-level synthesis tool and the hardware parameter; and
S4: obtaining execution time corresponding to the host code and the bitstream.

2. The device according to claim 1, wherein
the processor segments a trained model into the segmented model.

3. The device according to claim 1, wherein
the processor obtains operator execution time corresponding to an operator, wherein the trained model comprises the operator.

4. The device according to claim 3, wherein
the processor obtains the execution time corresponding to the host code and the bitstream by the operator execution time.

5. The device according to claim 1, wherein the reconfigurable hardware comprises a field programmable gate array.

6. The device according to claim 1, wherein the processing element comprises an adder tree, wherein a number of the adder tree is Tₘ, the adder tree comprises a multiplier, and a number of the multiplier is Tₙ.

7. The device according to claim 1, the tiling size corresponds to Tᵣ and T_{c}, wherein
the processor tiles a tensor into Tᵣ rows and T_{c} columns, wherein the processor inputs the tensor to the reconfigurable hardware.

8. The device according to claim 1, wherein the execution time comprises initial execution time and current execution time, wherein
when the current execution time is greater than or equal to the initial execution time, the processor re-executes steps S1 to S4.

9. A method for a model and a reconfigurable hardware, adaptable for a device comprising a processor, wherein the method comprises following steps:
S1: setting, by the processor, a number of pipeline stages and dividing points of pipelines as software parameters, and setting, by the processor, a tiling size, a number of a processing element, and a size of the processing element as a hardware parameter, wherein a segmented model comprises the pipeline stages and the dividing points, and the processing element corresponds to the reconfigurable hardware;
S2: compiling, by the processor, the segmented model by a machine learning compiler to obtain a host code;
S3: synthesizing, by the processor, a bitstream of the reconfigurable hardware by a high-level synthesis tool and the hardware parameter; and
S4: obtaining, by the processor, execution time corresponding to the host code and the bitstream.

10. The method according to claim 9, further comprising a following step:
segmenting, by the processor, a trained model into the segmented model.

11. The method according to claim 10, further comprising a following step:
obtaining, by the processor, operator execution time corresponding to an operator, wherein the trained model comprises the operator.

12. The method according to claim 11, wherein the step of obtaining, by the processor, the execution time corresponding to the host code and the bitstream comprises:
obtaining, by the processor, the execution time corresponding to the host code and the bitstream by the operator execution time.

13. The method according to claim 9, wherein the reconfigurable hardware comprises a field programmable gate array.

14. The method according to claim 9, wherein the processing element comprises an adder Tree, wherein a number of the adder tree is Tₘ, the adder tree comprises a multiplier, and a number of the multiplier is Tₙ.

15. The method according to claim 9, wherein the tiling size corresponds to Tᵣ and T_{c}, and the method further comprises a following step:
tiling, by the processor, a tensor into Tᵣ rows and T_{c} columns, wherein the processor inputs the tensor to the reconfigurable hardware.

16. The method according to claim 9, wherein the execution time comprises initial execution time and current execution time, and the method further comprises a following step:
when the current execution time is greater than or equal to the initial execution time, the processor re-executes steps S1 to S4.
